(19) United States
(12) Patent Application Publication
(10) Pub. No.: US 2022/0333749 A1
(43) Pub. Date: Oct. 20, 2022

(54) TRACKING TYPE SOLAR AND WIND-SOLAR HYBRID STREET LAMP

(71) Applicant: Jie LI, Nanning (CN)

(72) Inventor: Jie LI, Nanning (CN)

(21) Appl. No.: 17/858,298

(22) Filed: Jul. 6, 2022

Related U.S. Application Data
(63) Continuation of application No. PCT/CN2020/106952, filed on May 8, 2020.

(51) Int. Cl. F21S 8/08; H02S 20/32; F21S 9/03; H02S 10/12

(52) U.S. Cl. CPC F21S 8/085; H02S 20/32; F21S 9/035; H02S 10/12

(57) ABSTRACT

The present invention relates to the field of street lamp lighting, and more particularly to a tracking type solar and wind-solar hybrid street lamp, the current PV panels of solar and wind-solar hybrid street lamp is fixed installations and cannot be tracked, and the cost of existing tracking technology is expensive due to its complex structure, it is costly and cannot be applied to low-cost solar street lamps at all, how to solve the problem that street lamps can not only be able to tracking, but also have practical value have become a technical problem that needs to be solved urgently in the solar and wind-solar hybrid street lamp industry, the present invention provides a tracking technology that does not require a photoelectric sensor, and is constructed into a variety of tracking-type solar and wind-solar hybrid street lamp with different structures, which satisfactorily solves the above-mentioned problems.

### CROSS-REFERENCE TO RELATED APPLICATIONS

This is a Continuation Application of the International Application PCT/CN2020/106952, filed May 8, 2020.

### TECHNICAL FIELD

The present invention relates to the field of street lamp lighting, and more particularly to a tracking type solar and wind-solar hybrid street lamp.

### BACKGROUND

At present, the solar and wind-solar hybrid street lamp all over the world use fixed bracket technology, as a result the low power generation has affected its promotion and application in the market, in theory, the existing technology can make the solar and wind-solar hybrid street lamp have the tracking function, however, it needs to rely on the monitoring device to capture the solar altitude angle in real time in order to determine the change of PV panel angle, the complexity of the technology has led to its high cost, and it cannot be used on low-cost solar and wind-solar hybrid street lamp, these existing technologies are more for the pursuit of academic value, and it is difficult to directly transform and apply them, so they can only stay on paper-based existing technologies, how to solve the problem that solar and wind-solar hybrid street lamp can not only track the sun but also have practical value, and how to quickly install street lighting in areas where natural disasters occur and traffic is severely blocked, these are technical problems that need to be solved urgently in the field of solar and wind-solar hybrid street lamp.

### Technical Problem to be Solved

At present, the solar and wind-solar hybrid street lights in the market use untraceable fixed bracket technology. Due to the low power generation, it is difficult to meet the load demand, at a time when it is difficult to greatly improve the conversion rate of photovoltaic and wind power, how to improve the power generation efficiency of solar and wind-solar hybrid street lamps is a technical problem that needs to be solved urgently in the industry.

### SUMMARY

### What is the Technical Solution

Aiming at the above-mentioned defects, the present invention provides a tracking type solar and wind-solar hybrid street lamp, which solves the above-mentioned technical problems.

In order to achieve the above objective, the technical solution of the present invention is as follows:

A tracking type solar and wind-solar hybrid street lamp, it includes solar angle controller, battery, light source, light pole. PV panel, wind generator, the light poles are divided into two types: fixed and portable, the fixed light poles are divided into two types: light pole type or light pole and pillar combination type, the second type of light pole is fixed, the top pillar is a kind of smart electric column that can rotate, its column is mainly composed of shaft and hollow tube, the hollow tube is fixed on the shaft and rotates with the shaft and cannot move up and down, the base is fixedly connected to the bottom lamp pole, the portable light pole is liftable, it is composed of G hollow tubes and G nuts, G nuts have the same inner diameter but different outer diameters, the bottom of the hollow tube and the nut are fixedly connected to form a combination, the nut is a hollow cylinder, its outer diameter is greater than the outer diameter of the hollow tube in the same combination, except that the outer side of the nut of the bottom layer combination is smooth and unthreaded, the sides of the other nuts are all threaded structures, but there is unthreaded on the top and bottom, except that the nut of the bottom layer combination is fixedly installed on the shaft to rotate with the shaft, other combinations are sleeved on the shaft and rotate up and down along the shaft, except for the top of the lifting light pole, the inner side of the other hollow tubes are all threaded structures, in the G combinations, except for the lowest combination, each of the other combinations is installed on the hollow tube in the lower combination, the nut of the upper combination and the inner hollow tube of the lower combination form a screw transmission mechanism, and the top of the lowest combination is flush with the shaft, a ring is installed on the top of the shaft, the diameter of which is larger than that of the shaft, but smaller than the diameter of the inner hollow tube with the smallest diameter, the top of the light pole is movably connected with a smart electric column, the driving of the lamp pole lifting, the first is to use a combination of a motor and a mechanical transmission mechanism fixed in the base, the second is to manually rotate the mechanical transmission mechanism in the machine base, PV panels are divided into two types with and without modeling frame, there are 6 different combinations of the shape of the frame, the first type is a combination of polygon and polygon or circle and circle or ellipse and ellipse, there are 3 different types, the second type is a combination of polygon and circle or ellipse, there are 2 different types, the third type is a combination of an circle and an ellipse, there is only one type, the backlight surfaces are all color paintings with various types of patterns, tracking type solar and wind-solar complementary street lamp are divided into two types: integrated and non-integrated, the PV panels of the integrated solar and wind-solar hybrid street lamp is assembled together in a box with lamps, batteries, controllers and other devices to form a whole, the PV panels and lamp of non-integrated solar and wind-solar complementary street lamp is installed in different positions, the tracking mode of the system is divided into three different types: 1-dimensional tracking or 2-dimensional tracking without driving device, or 2-dimensional tracking with driving device, the 1-dimensional tracking can only adjust the azimuth, and the 2-dimensional tracking can adjust the azimuth and dip angle at the same time, in the 1-dimensional tracking solar street lamp, the bottom surface of the box of the integrated solar street lamp has II-shaped components installed horizontally and vertically, a curved column is installed at the intersection of the two, the integrated solar street light is obliquely fixed on the top of the column, the bottom end of the column is fixed on the top end of the smart electric column, among the non-integrated solar street lights, the number of PV panels is divided into two types, one or two, if the number of PV panels is 2, the frame at the junction uses two beams to connect the two PV panels together, the same type II components and columns as above are installed at the bottom of the integrated PV panel or the bottom of a separate PV panel, the installation method of the non-integrated solar street lamp and the column and the column fixed on the smart electric column is the same as the above-mentioned integrated street lamp, in the without driving device 2-dimensional tracking mode, the smart electric column is divided into two types: top type or side type, the two types of smart electric columns installed are T-shaped smart electric columns, the top-mounted type is installed on the top of the column or the upper section of the light pole, S bases are fixedly installed on the top wing of the T-shaped column of the smart electric column, each base is fixed with a rolling bearing or ring, a hollow tube P is fixed in S rolling bearings or rings, a combination containing 1 or 2 motors is installed in the hollow pipe P, the motor combination includes a motor, gear, and motor base, the gear is connected to the shaft of the motor and fixed inside the hollow tube, the motor is placed in the hollow tube P but not fixed to the inner wall, the motor is fixed on the motor frame, and the motor frame is fixed on the fastening components, the two ends of the hollow tube P are respectively connected to the runner of the fastening components, the fastening components at both ends are fixed on the bracket, the brackets are respectively fixed on both ends of the top of the T-shaped smart electric column, the bottom center of the non-integrated solar street lamp PV panel is fixed on the hollow tube P, the tail of the integrated solar street lamp is fixed on the hollow tube P, the side-mounted type is the smart electric column is installed on the side of the pillar or light pole, the two beams are respectively fixed to the pillar or light pole by the ring bracket bolt, one end of a supporting platform is fixed on the upper beam, N root support rods, one end is bolted to the supporting platform, the other end is bolted to the beam below, 1 root T-shaped smart electric column is fixed on the supporting platform, the beams are respectively fixed on the brackets on both sides of the T-shaped hollow tube of the smart electric column, a hollow tube P is fixed on the beam with S rings or rolling bearings, the structure of the hollow pipe P and the way of connecting with the fastening components are the same as the above-mentioned first top-end mounting type, but the bracket of the fastening member is fixed on the beam, the upper end of the PV panel is fixed on the hollow tube P with a fixed bracket, a safety rope is installed on the PV panel, there are two types of installation methods: without rope winder and with rope winder, the type of without rope winder is to install a beam with a concave groove on the frame or central axis on both sides of the back of the photovoltaic panel, the beam section is polygonal, and the opening is narrow at the top and wide at the bottom, a safety rope made of steel chain or steel wire rope, one end with a circular or polygonal fastener is buckled in the concave groove beam, the other end is respectively fixed on the two ends of the beam or the smart electric column, the type of with rope winder is to fix D rope reels on the hollow tube P, the safety rope of steel chain or steel wire rope has one end fixed in the rope winder and the other end fixed on the frame or central axis on both sides of the back of the PV panel, among the two-dimensional tracking solar street lamp with driving devices, the bottom structure of the PV panel of the integrated or non-integrated solar street light is the same as that of the 1-dimensional tracking, but the column is upright, the connection between the PV panel and the column, in non-integration, it is installed vertically, in integration, it is fixed to the top of the column vertically or obliquely, the bottom end of the column is connected with the smart electric column through a hinge device, the hinged device is composed of two T-shaped hollow tubes, the respective top ends are hingedly connected by the components of the hinge device to form a whole, one of the T-shaped hollow tubes is inserted or sleeved on the top of the smart electric column for a fixed connection, another T-shaped hollow tube is inserted into or sleeved on the bottom column of the PV panel or box to be bolted and connected, one end of the driving device is fixed to the smart electric column, and the other end is bolted to the bottom of the PV panel or the box, the driving device is an smart electric column, it is mainly composed of a polygonal or circular nut, a threaded shall, and a hollow tube, the bottom of the hollow tube is fixed on the nut to form a whole body, and the nut moves up and down along the shat, all the above-mentioned smart electric columns fixed on the machine base, and their driving is carried out by a combination of a motor and a mechanical transmission mechanism fixed in the machine base, in wind-solar hybrid street lamp, the smart electric column on the upper part of the pole is a T-shaped hollow tube or a straight hollow tube, the cross beam is fixed on the smart electric column in two ways, in the first way, the cross beam is fixed on the straight hollow tube through a ring bracket, in the second way, the cross beam is fixed on the sagging bracket on both sides of the T-shaped hollow pipe by bolts, in the 1-dimensional tracking wind-solar hybrid street lamp, only adjust the azimuth, the top bolt of the PV panel is fixed on the cross beam, and the lower end or middle part is supported in an inclined state by a triangular bracket and fixed on the smart electric column, in the 2-dimensional tracking wind-solar hybrid street lamp, a hollow tube P is fixed on the cross beam with S rings or rolling bearings, the internal structure and installation method of the hollow tube P are the same as those of the above-mentioned solar street lamp without driving device for 2-dimensional tracking, but the brackets of the fastening components at both ends are fixed on the cross beam, the PV panel is fixed on the hollow tube P with a fixing bracket, the safety rope is installed on the PV panel, and its installation is the same as the above-mentioned side-mounted type, in the integrated solar street lamp, the tail part of the box body is fixed on the cross beam or the hollow tube P, safety ropes of the same type as the above are installed on the side frames or the central axis of the box, a wind generator is installed on the top of T-shaped hollow tube or straight hollow tube, wind generators include two different types of horizontal axis and vertical axis, the angle adjustment of solar and wind-solar hybrid street lamp is to adjust the angle of PV panel, it will be controlled by a solar angle controller with an embedded angle sensor, the solar angle controller is an smart control device which controls the angle of PV panel to change by using time timing, it mainly includes main chip, angle sensor, GPS satellite positioning or electronic compass, clock chip. Bluetooth, motor-driven module, the main chip reads the real-time clock and angle value, and controls the change of the PV panel angle according to different time periods, after the solar angle controller is powered on, the clock chip will automatically use GPS or Bluetooth to check the time, the working principle of PV panel angle adjustment is: the solar angle controller and the PV panel are installed on the same horizontal plane, when the time reaches the preset time, the solar angle controller receives a signal to adjust the angle, then, the angle detection module is made to rotate by controlling the control module of the motor to make the PV panel complete the horizontal or inclined action, at this time, the smart electric column will complete the horizontal or extension or contraction movement with the rotation of the motor, while the PV panel is pushed to the predetermined position, the analog output from the angle sensor is converted by the analog-digital converter and then sent to the main controller, according to this input, the main controller determines whether the PV panel has been rotated to a predetermined angle, and according to this to control the control module of the motor, thus an angle adjustment is completed, in the many times adjustment mode within 1 day of dip angle, the angle value newly adjusted each time is ψ−J*ψ/F in the morning period, at noon, the dip angle is fixed, and it is γ+ψ/F in the afternoon, the calculated dip angle value that needs to be adjusted each time is input into the storage module of the controller together with the corresponding analog voltage value or adjustment time, the specific implementation is: when the angle sensor is in the horizontal position and the angle is 0°, the output terminal Vo outputs an analog voltage of A volts, when the angle value ψ of the maximum dip angle between the angle sensor and the horizontal plane, the output at this time is the analog voltage of B volts, when the angle of the angle sensor changes in the interval of 0°˜ψ or ψ˜180°, the voltage output by the output terminal Vo will sequentially change from A volts to B volts or B volts to A volts analog voltage signal, therefore, by measuring the voltage at the output terminal Vo of the angle sensor, the angle between the PV panel and the horizontal plane can be determined, the component of the hinge device is composed of a bottom plate and a C-block polygonal vertical plate, one end of the are in the vertical plate has a hole, and the other end is fixed on the bottom plate, the components of the hinged device, when C=2, are fixed connections, when C>2, it is hinged connection to form a hinged device, it is characterized in that: no photoelectric sensor device is required, and different combinations of smart electric columns, drive motors, PV panels fixed or movable brackets are used respectively, constructed into a variety of different types of tracking type solar and wind-solar hybrid street lamp; using time timing, the angle adjustment of the PV panel is controlled by a solar angle controller, the solar angle controller is timed according to time, by controlling the smart electric column or driving motor to drive the azimuth angle of the PV panel to move horizontally to the east or west, or to rotate the dip angle from east to west, thus, the azimuth or dip angle of the PV panel is adjusted to change with the change of time, the order of adjustment is azimuth adjustment first and dip angle later, the azimuth angle is adjusted by the solar angle controller to control it to rotate eastward or westward according to the signal output by the GPS or the electronic compass module, the adjustment of the dip angle is a beforehand inputting method, the beforehand inputting method is the dip angle value calculated by the arithmetic average method of the maximum inclination angle, it is a control mode in which the alone dip angle value or its corresponding analog voltage value or adjustment time are input into the controller in advance, the maximum inclination arithmetic averaging method refers to the period of morning or afternoon, the maximum dip angle that PV panels can form, a calculation method for arithmetic average according to the number of adjustments, the time timing is three or many times in one day, the adjusted time period of the 2-dimensional tracking is divided into three time periods: morning, noon, and afternoon, three adjustments within a day, in the morning, the PV panel faces east with the largest dip angle; at noon, the PV panels are horizontal; in the afternoon, the PV panel faces west with the largest dip angle, the many times adjustments refer to two periods in the morning or afternoon, the azimuth angle is adjusted every E minutes, and the dip angle is adjusted F times in E minutes, the angle value of the maximum dip angle ψ of the PV panel in the input method is divided into F times in arithmetic average, the angle value of each adjustment is ψ/F, the orientation of the PV panel adjusted for many times is the same as that adjusted for three times within a day, in the morning, the newly adjusted angle value is ψ−J*ψ/F each time. J is an integer number series value, the minimum value is 1, the maximum value is F; in the afternoon, the newly adjusted angle value is γ+ψ/F each time, γ is the angle value at the previous moment of adjustment, when every time the azimuth is adjusted, the dip angle has retuned to the initial position, the 1-dimensional tracking solar angle controller without driving device is installed horizontally with the PV panel, the number of azimuth adjustments is the sum of all adjustment times in a day, calculated at every interval of D minutes, in the 2-dimensional tracking mode without a driving device, the angle of each rotation of the motor in the hollow tube P is the same as the angle of each dip angle adjustment described above.

### Beneficial Effect

The tracking solar and wind-solar hybrid street lamp technologies with six different structures provided by the present invention improve the power generation efficiency of solar and wind-solar hybrid street lamps when the conversion rate of photovoltaic or wind power is difficult to be greatly improved, it solves the technical problems that need to be solved urgently in the solar and wind-solar hybrid street lamps industry, that is, solar and wind-solar hybrid street lamps must not only be able to track the sun, but also have practical value.

### BRIEF DESCRIPTION OF DRAWINGS

FIG. 1 is a front view of a 2-dimensional tracking mode with a driving device: 1—PV pawl, 2—drive device, 3—light source, 4—hinge device formed by hinged connection of two T-shaped hollow tubes, 5—Vertical column at the bottom of the PV panel, 6—Smart electric column, 7—Light pole;

FIG. 2 is a front view of a 1-dimensional tracking mode without a drive device: 8—Curved column at the bottom of the PV panel

FIG. 3 is a plan view of the 2-dimensional tracking mode without a driving device: 9—base of rolling bearing, 10—rolling bearing or ring, 11—hollow tube P, 12—top of T-shaped smart electric column, 13—fastening component, 14—motor, 15—gear, 16—T-shaped smart electric column;

FIG. 4 is a front view of a 2-dimensional tracking mode without a drive device: 17—bracket of the fastening component, 18—fixing bracket of the PV panel;

FIG. 5 is a front view of the 1-dimensional tracking mode of wind-solar hybrid street lamp: 19—blade of the vertical axis fan, 20—shaft of the vertical axis fan, 21—generator of the vertical axis fan, 22—T-shaped hollow tube, 23—brackets hanging down on both sides of the top of the T-shaped hollow tube, 24—crossbeam, 25—PV panel, 26—triangular fixed bracket, 27—smart electric column, 28—lower end of the light pole;

FIG. 6 is a front view of the 2-dimensional tracking mode of wind-solar hybrid street lamp: 29—vertical axis fan, 30—bracket of the PV panel fixed on the hollow tube P, 31—ring or rolling bearing, 32—hollow pipe P, 33—bracket of the fastening component, 34—safety rope of steel chain or wire rope, 35—concave groove beam;

FIG. 7 is the back of the PV panel installed in the modeling frame; 36—modeling frame,

FIG. 8 is the front of the PV panel installed in the modeling frame.

### DETAILED DESCRIPTION OF THE EMBODIMENTS

### Preferred Embodiment of the Present Invention

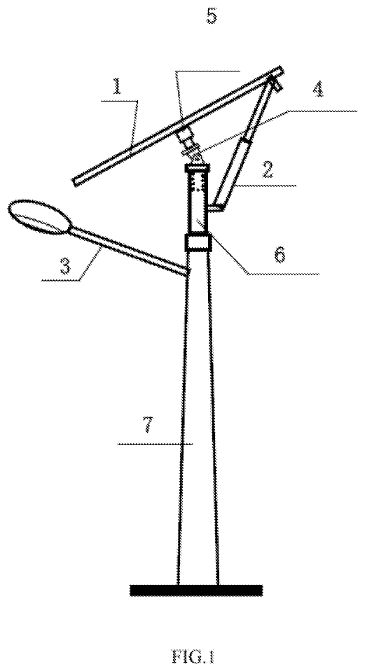

Referring to FIG. 1, the column 5 at the bottom of the PV panel 1 and the intelligent electric column 6 are connected together by the hinge device 4, and are bolted to the driving device 2, the driving device 2 is bolted and connected to the smart electric column 6, and the smart electric column 6 is fixedly connected to the top of the light pole 7 through the base, thereby forming a 2-dimensional tracking solar street light.

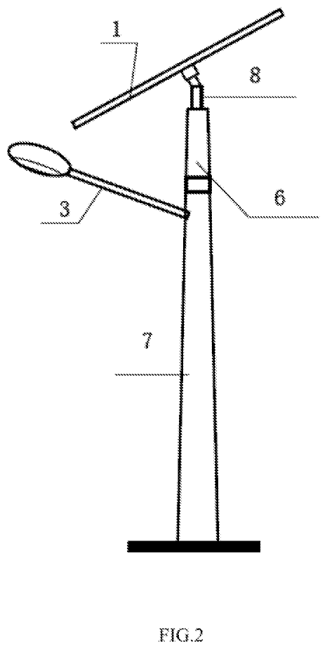

Referring to FIG. 2, the structure of the tracking system is basically the same as that of the above-mentioned 2-dimensional tracking system, except that the driving device and the hinge device are not installed, the PV panel 1 is fixedly installed on the top of the column 9, and the bottom of the column 9 is inserted into or sleeved on the top of the smart electric column 6 and by bolts fixed, thereby forming a 1-dimensional tracking solar street light.

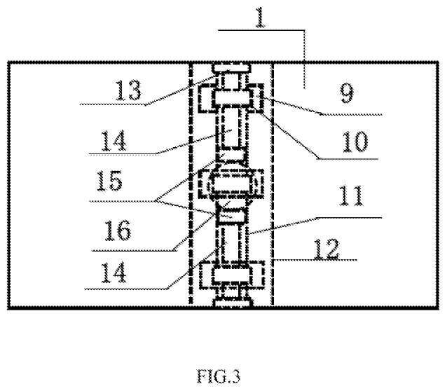

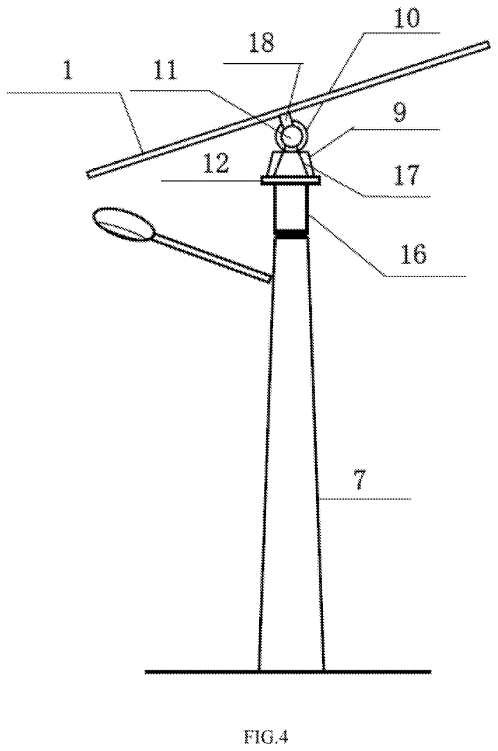

Referring to FIGS. 3-4, the PV panel 1 is fixed on the hollow tube P11 by a fixing bracket 18, the hollow tube P11 is fixed on the rolling bearing or ring 10, and the rolling bearing or ring 10 is fixed on the base 9, the base 9 is fixed on the top end 12 of the T-shaped smart electric column 16, the motor 14 and the gear 15 are installed in the hollow tube P11, the gear 15 is connected with the shalt of the motor 7 and fixed on the inner side of the hollow tube P11, the motor 14 is fixed on the fastening component 13 through a motor base, the two ends of the hollow tube P11 are respectively connected to the runners of the fastening component 13, the fastening component 13 is fixedly installed on the bracket 17, and the bracket 17 is fixed on the top end 12 of the T-shaped smart electric column 16. T-shaped smart electric column 16 is inserted or sleeved on the smart electric column 6 and fixed with bolts, thus, a 2-dimensional tracking solar street lamp without driving device is constructed.

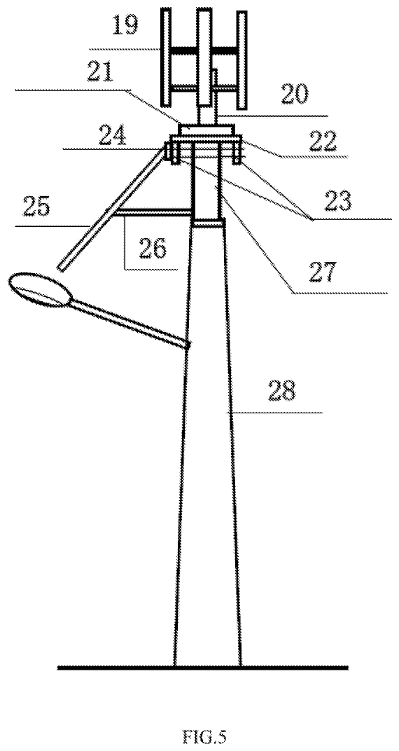

Referring to FIG. 5, the blades 19 of the vertical axis wind generator are fixed on the rotating shaft 20, the rotating shaft 20 is fixed on the wind generator 21, the wind generator 21 is fixed at the center of the top end of the T-shaped hollow tube 22 of the smart electric column 27, a crossbeam 24 is fixed on the brackets 23 on both sides of the top end of the T-shaped hollow tube 22, the top of the PV panel 25 is fixed on the crossbeam 24, its lower end or middle part is fixed on the smart electric column 27 by triangular fixing bracket 26, the smart electric column 27 is fixed on the top of the light pole 28, thus, a 1-dimensional tracking wind-solar hybrid street lamp without driving device is constructed.

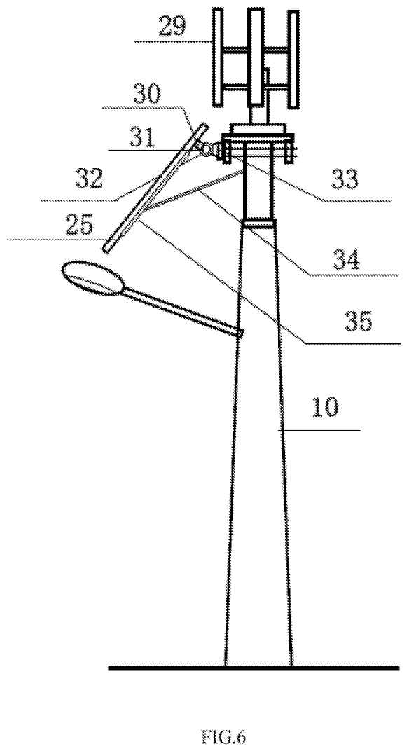

Referring to FIG. 6, the vertical axis wind generator device 29 is installed at the top of the T-shaped hollow tube 22, the PV panel 25 is fixed on the hollow tube P32, and the hollow tube P32 is fixed on the rolling bearing or ring 31, the rolling bearing or ring 31 is fixed on the cross beam 24, and the cross beam 24 is fixed on the brackets 23 on both sides of the top end of the T-shaped hollow tube 22, the shaft of the motor is connected with the gear and installed in the hollow tube P32, the gear is connected with the rotating shaft of the motor, and the gear is fixed inside the hollow tube P32, the motor is fixed on the fastening component through the motor base, the fastening component is fixedly installed on the bracket 33, and the bracket 33 is fixed on the cross beam 24, a beam 35 with a concave groove is respectively installed on the frame or the central axis on both sides of the back of the PV panel 25, one end of a steel chain or wire rope 34 is buckled in the concave groove beam 35, the other end is respectively fixed on both ends of the cross beam 24 or the smart electric column 27, thus, a 2-dimensional tracking wind-solar hybrid street lamp without driving device is constructed.

### EMBODIMENT OF THE INVENTION

The angle is adjusted three or more times a day, the adjusted time period of the 2-dimensional tracking is divided into three time periods: morning, noon, and afternoon, three adjustments within a day, in the morning, the PV panel faces east with the largest dip angle; at noon, the PV panels are horizontal; in the afternoon, the PV panel faces west with the largest dip angle, the azimuth angle is adjusted every E minutes, and the dip angle is adjusted F times in E minutes, the angle value of the maximum dip angle ψ of the PV panel in the input method is divided into F times in arithmetic average, the angle value of each adjustment is ψ/F, the orientation of the PV panel adjusted for many times is the same as that adjusted for three times within one day, in the morning, the newly adjusted angle value is ψ−J*ψ/F each time, J is an integer number series value, the minimum value is 1, the maximum value is F; in the afternoon, the newly adjusted angle value is γ+ψ/F each time, γ is the angle value at the previous moment of adjustment, every time the azimuth is adjusted, the dip angle has returned to the initial position, the 1-dimensional tracking solar angle controller without driving device is installed horizontally with the PV panel, the number of azimuth adjustments is the sum of all adjustment times in a day, calculated at every interval of D minutes, in the 2-dimensional tracking mode without a driving device, the angle of each rotation of the motor in the hollow tube P is the same as the angle of each dip angle adjustment described above.

Referring to FIG. 1, which is 2-dimensional tracking solar street lamp with a driving device, after starting the power of the solar angle controller, the PV panel will return to the position where it should be at the local time under the control of the controller, at a predetermined moment, first adjust the azimuth angle of the PV panel 1, the solar angle controller will obtain the azimuth angle of the sun facing cast or west according to the signal output by the electronic compass module, the motor rotation of the smart electric column 6 is controlled by the solar angle controller, drive the shaft to rotate through the mechanical transmission mechanism in the base, when the shaft rotates, it also drives the column body of the smart electric column 6 to rotate in the same direction, and the PV panel 1 rotates in place, the driving device 2 also starts to adjust the inclination angle after it rotates in place at the same time. For the specific adjustment method, please refer to paragraph 0020 for specific adjustments.

Referring to FIG. 2 which is a 1-dimensional tracking solar street lamp without a driving device, in the 1-dimensional tracking system, which only the azimuth angle can be adjusted, please refer to paragraph 0021 for specific adjustments.

Referring to FIGS. 3-4, at a predetermined time, first adjust the azimuth of PV panel 1, the adjustment of the azimuth angle of the PV panel 1, please refer to paragraph 0021 for specific adjustments, the adjustment of the inclination angle is carried out by using a solar angle controller to control the rotation of the motor 14 in the hollow tube P11, while the motor 14 rotates, it drives the PV panel 1 to rotate in the same direction, so that the inclination angle of the PV panel 1 is changed, the angle of each rotation of the motor 14 in the hollow tube P11 is the same as the angle of each inclination adjustment. For the specific angle adjustment method, please refer to paragraphs 0020-0021 for specific adjustments.

Referring to FIG. 5, which is a 1-dimensional tracking wind-solar hybrid street lamp without driving device, after starting the power of the solar angle controller, the PV panel 25 will return to the position where it should be at the local time under the control of the controller, at a predetermined moment, first adjust the azimuth angle of the PV panel 1, the solar angle controller will obtain the azimuth angle of the sun facing cast or west according to the signal output by the electronic compass module, the solar angle controller controls the rotation of the motor of the smart electric column 27, the shaft is driven to rotate through the transmission mechanism, when the shaft rotates, it also drives the T-shaped hollow tube 22 to rotate in the same direction, and the photovoltaic panel 25 rotates in place with the smart electric column 27, the blade 19 of the vertical axis fan is fixed on the rotating shaft 20, the rotating shaft 20 is fixed on the top cover of the generator 21, and the generator 21 is fixed on the top of the T-shaped hollow tube 22 through the bottom cover, the blade 19 of the vertical axis wind generator rotates under the action of the wind, which drives the shaft 20 to rotate in the same direction, the rotating shaft 20 will drive the top cover of the generator 21 to rotate at the same time, the rotor inside the generator 21 also rotates, cutting the stator and generating electricity, the rotation of the smart electric column 27 and the rotating shaft 20 of the vertical axis wind generator are performed independently.

Referring to FIG. 6, which is a 2-dimensional tracking wind-solar hybrid street lamp without driving device, after starting the power of the solar angle controller, the PV panel 25 will return to the position where it should be at the local time under the control of the controller, for the specific adjustment mode of PV panel 25 angle and the working mode of vertical axis wind generator, please refer to paragraphs 0020-0024 for specific adjustments, the safety rope 34 in the rope reel will shrink or extend with the rotation of the hollow tube P11, and the safety rope 34 will slide up and down in the concave groove 35 with the movement of the PV panel 25, its function is to avoid damage to the PV panel 25 under extreme weather, after each adjustment, the system will automatically return to its original state, after the power is turned off, the motor is self-locking, and the PV panel 25 forms a vertical state with the ground.

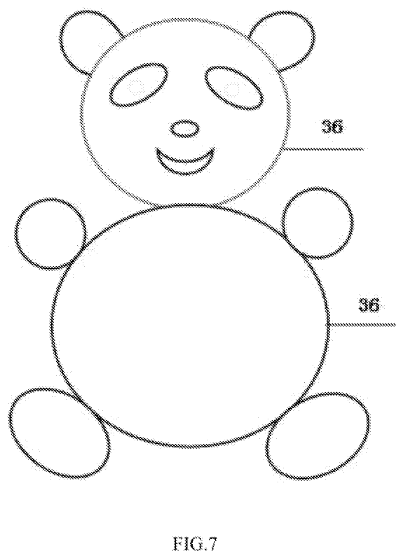

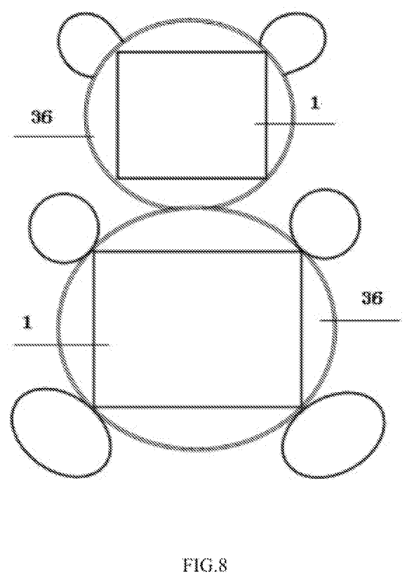

Street lamp is a beautiful scenery of a city, FIGS. 7-8, it is a PV panel with various shapes, this is an ornamental solar panel that can be integrated into the local landscape, it will change the monotonous and rigid colors of the current solar and wind-solar hybrid street light photovoltaic panels, adding beauty to the city.

### INDUSTRIAL APPLICABILITY

A tracking type solar and wind-solar hybrid street lamp of the present invention, provide six different structure tracking solar and wind-solar hybrid street light technologies, it is a new type of non-inductive tracking technology which is different from the known fixed bracket technology and inductive tracking technology, which technology is simple, the cost is low, and the self-loss power is small, at the moment when it is difficult to greatly improve the photoelectric conversion rate, the power generation efficiency is improved, solve the technical problems that need to be solved urgently in the solar and wind-solar hybrid street lamp industry, that is to say, solar and wind-solar hybrid street lamp must not only be able to tracking, but also have practical value, the solar and wind-solar hybrid street lamp of the present invention has an average increase of about 60% in power generation compared with the fixed bracket technology without tracking, and has good economic and ecological benefits, it provides strong technical support for the large-scale promotion and application of solar and wind-solar hybrid street lights, when monitoring equipment or signal lights are used to replace lamps, it becomes five different types of tracking monitoring systems or signal light systems; when the facilities of intelligent monitoring, environmental monitoring, road monitoring, and 5G micro base station are installed on the light pole, the wind-solar hybrid street light will be transformed into a smart light pole.

What is claimed is:

1. A tracking type solar and wind-solar hybrid street lamp, it includes solar angle controller, battery, light source, light pole, PV panel, wind generator, the light poles are divided into two types: fixed and portable, the fixed light poles are divided into two types: light pole type or light pole and pillar combination type, the second type of light pole is fixed, the top pillar is a kind of smart electric column that can rotate, its column is mainly composed of shaft and hollow tube, the hollow tube is fixed on the shaft and rotates with the shaft and cannot move up and down, the base is fixedly connected to the bottom lamp pole, the portable light pole is liftable, it is composed of G hollow tubes and G nuts, G nuts have the same inner diameter but different outer diameters, the bottom of the hollow tube and the nut are fixedly connected to form a combination, the nut is a hollow cylinder, its outer diameter is greater than the outer diameter of the hollow tube in the same combination, except that the outer side of the nut of the bottom layer combination is smooth and unthreaded, the sides of the other nuts are all threaded structures, but there is unthreaded on the top and bottom, except that the nut of the bottom layer combination is fixedly installed on the shaft to rotate with the shaft, other combinations are sleeved on the shaft and rotate up and down along the shaft, except for the top of the lifting light pole, the inner side of the other hollow tubes are all threaded structures, in the G combinations, except for the lowest combination, each of the other combinations is installed on the hollow tube in the lower combination, the nut of the upper combination and the inner hollow tube of the lower combination form a screw transmission mechanism, and the top of the lowest combination is flush with the shaft, a ring is installed on the top of the shaft, the diameter of which is larger than that of the shaft, but smaller than the diameter of the inner hollow tube with the smallest diameter, the top of the light pole is movably connected with a smart electric column, the driving of the lamp pole lifting, the first is to use a combination of a motor and a mechanical transmission mechanism fixed in the base, the second is to manually rotate the mechanical transmission mechanism in the machine base, PV panels are divided into two types with and without modeling frame, there are 6 different combinations of the shape of the frame, the first type is a combination of polygon and polygon or circle and circle or ellipse and ellipse, there are 3 different types, the second type is a combination of polygon and circle or ellipse, there are 2 different types, the third type is a combination of an circle and an ellipse, there is only one type, the backlight surfaces are all color paintings with various types of patterns, tracking type solar and wind-solar complementary street lamp are divided into two types: integrated and non-integrated, the PV panels of the integrated solar and wind-solar hybrid street lamp is assembled together in a box with lamps, batteries, controllers and other devices to form a whole, the PV panels and lamp of non-integrated solar and wind-solar complementary street lamp is installed in different positions, the tracking mode of the system is divided into three different types: 1-dimensional tracking or 2-dimensional tracking without driving device, or 2-dimensional tracking with driving device, the 1-dimensional tracking can only adjust the azimuth, and the 2-dimensional tracking can adjust the azimuth and dip angle at the same time, in the 1-dimensional tracking solar street lamp, the bottom surface of the box of the integrated solar street lamp has II-shaped components installed horizontally and vertically, a curved column is installed at the intersection of the two, the integrated solar street light is obliquely fixed on the top of the column, the bottom end of the column is fixed on the top end of the smart electric column, among the non-integrated solar street lights, the number of PV panels is divided into two types, one or two, if the number of PV panels is 2, the frame at the junction uses two beams to connect the two PV panels together, the same type II components and columns as above are installed at the bottom of the integrated PV panel or the bottom of a separate PV panel, the installation method of the non-integrated solar street lamp and the column and the column fixed on the smart electric column is the same as the above-mentioned integrated street lamp, in the without driving device 2-dimensional tracking mode, the smart electric column is divided into two types: top type or side type, the two types of smart electric columns installed are T-shaped smart electric columns, the top-mounted type is installed on the top of the column or the upper section of the light pole, S bases are fixedly installed on the top wing of the T-shaped column of the smart electric column, each base is fixed with a rolling bearing or ring, a hollow tube P is fixed in S rolling bearings or rings, a combination containing 1 or 2 motors is installed in the hollow pipe P, the motor combination includes a motor, gear, and motor base, the gear is connected to the shaft of the motor and fixed inside the hollow tube, the motor is placed in the hollow tube P but not fixed to the inner wall, the motor is fixed on the motor frame, and the motor frame is fixed on the fastening components, the two ends of the hollow tube P are respectively connected to the runner of the fastening components, the fastening components at both ends are fixed on the bracket, the brackets are respectively fixed on both ends of the top of the T-shaped smart electric column, the bottom center of the non-integrated solar street lamp PV panel is fixed on the hollow tube P, the tail of the integrated solar street lamp is fixed on the hollow tube P, the side-mounted type is the smart electric column is installed on the side of the pillar or light pole, the two beams are respectively fixed to the pillar or light pole by the ring bracket bolt, one end of a supporting platform is fixed on the upper beam, N root support rods, one end is bolted to the supporting platform, the other end is bolted to the beam below, 1 root T-shaped smart electric column is fixed on the supporting platform, the beams are respectively fixed on the brackets on both sides of the T-shaped hollow tube of the smart electric column, a hollow tube P is fixed on the beam with S rings or rolling bearings, the structure of the hollow pipe P and the way of connecting with the fastening components are the same as the above-mentioned first top-end mounting type, but the bracket of the fastening member is fixed on the beam, the upper end of the PV panel is fixed on the hollow tube P with a fixed bracket, a safety rope is installed on the PV panel, there are two types of installation methods: without rope winder and with rope winder, the type of without rope winder is to install a beam with a concave groove on the frame or central axis on both sides of the back of the photovoltaic panel, the beam section is polygonal, and the opening is narrow at the top and wide at the bottom, a safety rope made of steel chain or steel wire rope, one end with a circular or polygonal fastener is buckled in the concave groove beam, the other end is respectively fixed on the two ends of the beam or the smart electric column, the type of with rope winder is to fix D rope reels on the hollow tube P, the safety rope of steel chain or steel wire rope has one end fixed in the rope winder and the other end fixed on the frame or central axis on both sides of the back of the PV panel, among the two-dimensional tracking solar street lamp with driving devices, the bottom structure of the PV panel of the integrated or non-integrated solar street light is the same as that of the 1-dimensional tracking, but the column is upright, the connection between the PV panel and the column, in non-integration, it is installed vertically, in integration, it is fixed to the top of the column vertically or obliquely, the bottom end of the column is connected with the smart electric column through a hinge device, the hinged device is composed of two T-shaped hollow tubes, the respective top ends are hingedly connected by the components of the hinge device to form a whole, one of the T-shaped hollow tubes is inserted or sleeved on the top of the smart electric column for a fixed connection, another T-shaped hollow tube is inserted into or sleeved on the bottom column of the PV panel or box to be bolted and connected, one end of the driving device is fixed to the smart electric column, and the other end is bolted to the bottom of the PV panel or the box, the driving device is an smart electric column, it is mainly composed of a polygonal or circular nut, a threaded shaft, and a hollow tube, the bottom of the hollow tube is fixed on the nut to form a whole body, and the nut moves up and down along the shaft, all the above-mentioned smart electric columns fixed on the machine base, and their driving is carried out by a combination of a motor and a mechanical transmission mechanism fixed in the machine base, in wind-solar hybrid street lamp, the smart electric column on the upper part of the pole is a T-shaped hollow tube or a straight hollow tube, the cross beam is fixed on the smart electric column in two ways, in the first way, the cross beam is fixed on the straight hollow tube through a ring bracket, in the second way, the cross beam is fixed on the sagging bracket on both sides of the T-shaped hollow pipe by bolts, in the 1-dimensional tracking wind-solar hybrid street lamp, only adjust the azimuth, the top bolt of the PV panel is fixed on the cross beam, and the lower end or middle part is supported in an inclined state by a triangular bracket and fixed on the smart electric column, in the 2-dimensional trucking wind-solar hybrid street lamp, a hollow tube P is fixed on the cross beam with S rings or rolling bearings, the internal structure and installation method of the hollow tube P are the same as those of the above-mentioned solar street lamp without driving device for 2-dimensional tracking, but the brackets of the fastening components at both ends am fixed on the cross beam, the PV panel is fixed on the hollow tube P with a fixing bracket, the safety rope is installed on the PV panel, and its installation is the same as the above-mentioned side-mounted type, in the integrated solar street lamp, the tail part of the box body is fixed on the cross beam or the hollow tube P, safety ropes of the same type as the above are installed on the side frames or the central axis of the box, a wind generator is installed on the top of T-shaped hollow tube or straight hollow tube, wind generators include two different types of horizontal axis and vertical axis, the angle adjustment of solar and wind-solar hybrid street lamp is to adjust the angle of PV panel, it will be controlled by a solar angle controller with an embedded angle sensor, the solar angle controller is an smart control device which controls the angle of PV panel to change by using time timing, it mainly includes main chip, angle sensor, GPS satellite positioning or electronic compass, clock chip, Bluetooth, motor-driven module, the main chip reads the real-time clock and angle value, and controls the change of the PV panel angle according to different time periods, after the solar angle controller is powered on, the clock chip will automatically use GPS or Bluetooth to check the time, the working principle of PV panel angle adjustment is: the solar angle controller and the PV panel are installed on the same horizontal plane, when the time reaches the preset time, the solar angle controller receives a signal to adjust the angle, then, the angle detection module is made to rotate by controlling the control module of the motor to make the PV panel complete the horizontal or inclined action, at this time, the smart electric column will complete the horizontal or extension or contraction movement with the rotation of the motor, while the PV panel is pushed to the predetermined position, the analog output from the angle sensor is converted by the analog-digital converter and then sent to the main controller, according to this input, the main controller determines whether the PV panel has been rotated to a predetermined angle, and according to this to control the control module of the motor, thus an angle adjustment is completed, in the many times adjustment mode within 1 day of dip angle, the angle value newly adjusted each time is ψ−J*ψ/F in the morning period, at noon, the dip angle is fixed, and it is γ+ψ/F in the afternoon, the calculated dip angle value that needs to be adjusted each time is input into the storage module of the controller together with the corresponding analog voltage value or adjustment time, the specific implementation is: when the angle sensor is in the horizontal position and the angle is 0°, the output terminal Vo outputs an analog voltage of A volts, when the angle value ψ of the maximum dip angle between the angle sensor and the horizontal plane, the output at this time is the analog voltage of B volts, when the angle of the angle sensor changes in the interval of 0°˜ψ or ψ˜180°, the voltage output by the output terminal Vo will sequentially change from A volts to B volts or B volts to A volts analog voltage signal, therefore, by measuring the voltage at the output terminal Vo of the angle sensor, the angle between the PV panel and the horizontal plane can be determined, the component of the hinge device is composed of a bottom plate and a C-block polygonal vertical plate, one end of the are in the vertical plate has a hole, and the other end is fixed on the bottom plate, the components of the hinged device, when C=2, are fixed connections, when C>2, it is hinged connection to form a hinged device, it is characterized in that: no photoelectric sensor device is required, and different combinations of smart electric columns, drive motors, PV panels fixed or movable brackets are used respectively, constructed into a variety of different types of tracking type solar and wind-solar hybrid street lamp: using time timing, the angle adjustment of the PV panel is controlled by a solar angle controller.

2. A tracking type solar and wind-solar hybrid street lamp according to claim 1, which is characterized by: the solar angle controller is timed according to time, by controlling the smart electric column or driving motor to drive the azimuth angle of the PV panel to move horizontally to the east or west, or to rotate the dip angle from east to west, thus, the azimuth or dip angle of the PV panel is adjusted to change with the change of time, the order of adjustment is azimuth adjustment first and dip angle later, the azimuth angle is adjusted by the solar angle controller to control it to rotate eastward or westward according to the signal output by the GPS or the electronic compass module, the adjustment of the dip angle is a beforehand inputting method, the beforehand inputting method is the dip angle value calculated by the arithmetic average method of the maximum inclination angle, it is a control mode in which the alone dip angle value or its corresponding analog voltage value or adjustment time are input into the controller in advance, the maximum inclination arithmetic averaging method refers to the period of morning or afternoon, the maximum dip angle that PV panels can form, a calculation method for arithmetic average according to the number of adjustments.

3. A tracking type solar and wind-solar hybrid street lamp according to claim 2, which is characterized by: the time timing is three or many times in one day, the adjusted time period of the 2-dimensional tracking is divided into three time periods: morning, noon, and afternoon, three adjustments within a day, in the morning, the PV panel faces east with the largest dip angle; at noon, the PV panels are horizontal; in the afternoon, the PV panel faces west with the largest dip angle, the many times adjustments refer to two periods in the morning or afternoon, the azimuth angle is adjusted every E minutes, and the dip angle is adjusted F times in E minutes, the angle value of the maximum dip angle ψ of the PV panel in the input method is divided into F times in arithmetic average, the angle value of each adjustment is ψ/F, the orientation of the PV panel adjusted for many times is the same as that adjusted for three times within a day, in the morning, the newly adjusted angle value is ψ−J*ψ/F each time, J is an integer number series value, the minimum value is 1, the maximum value is F; in the afternoon, the newly adjusted angle value is γ+ψ/F each time, γ is the angle value at the previous moment of adjustment, when every time the azimuth is adjusted, the dip angle has returned to the initial position, the 1-dimensional tracking solar angle controller without driving device is installed horizontally with the PV panel, the number of azimuth adjustments is the sum of all adjustment times in a day, calculated at every interval of D minutes, in the 2-dimensional tracking mode without a driving device, the angle of each rotation of the motor in the hollow tube P is the same as the angle of each dip angle adjustment described above.
